(19) United States
(12) Patent Application Publication
(10) Pub. No.: US 2015/0227243 A1
(43) Pub. Date: Aug. 13, 2015

(54) DESIGN OF DUMMY AREA AND SPACE AREA OF TOUCH PANEL AND METHOD THEREOF

(71) Applicant: Henghao Technology Co., Ltd., Hsinchu County (TW)

(72) Inventors: Cheng-Kai Wang, Hukou Township (TW); Pei-Chen Tang, Hukou Township (TW); Wei-Wen Wang, Hukou Township (TW)

(21) Appl. No.: 14/313,692

(22) Filed: Jun. 24, 2014

(30) Foreign Application Priority Data
Feb. 12, 2014 (TW) 103104640

(51) Int. Cl. G06F 3/046

(52) U.S. Cl. CPC G06F 3/046

(57) ABSTRACT

Configurations of a touch panel having a dummy area and a space area, and methods thereof are disclosed. The proposed touch panel includes the dummy area having a first width and the space area having a second width, wherein the second width and the first width have a ratio being no larger than 0.2.

### CROSS-REFERENCE TO RELATED APPLICATION

This application claims the benefit of Taiwan Patent Application Number 103104640 filed on Feb. 12, 2014, at the Taiwan Intellectual Property Office, the disclosure of which is incorporated herein in its entirety by reference.

### FIELD OF THE INVENTION

The present invention relates to a touch panel design and a method thereof, in particular to a touch panel design and a method thereof causing an etching mark formed by a space area to he invisible to the naked eye.

### BACKGROUND OF THE INVENTION

If the dummy area of a transparent electrode of a touch panel is designed to be too small, it will cause the human eye to generate an illusion that makes the visibility of an etching mark obvious.

Finding the optimum ratio of the dummy and the space areas of the touch panel to cause the etching marks of patterns of the transparent conducting film (e.g., ITO) to be invisible to the naked eye of a user of the touch panel is worthy of further research and improvement.

Keeping the drawbacks of the prior arts in mind, and through the use of robust and persistent experiments and research, the applicant has finally conceived a design of dummy area and space area of a touch panel and a method thereof.

### SUMMARY OF THE INVENTION

It is an objective of the present invention to provide a touch panel, wherein there is a specific ratio of the dummy and the space areas of the transparent electrode to cause the etching marks of patterns in the transparent conducting film (e.g., ITO) to be invisible to the naked eye of a user of the touch panel.

In accordance with the first aspect of the present invention a touch panel includes a plurality of touch units, each of which comprises a dummy area having a first width, and a first space area adjacent to the dummy area and having a second width, wherein a ratio of the second width to the first width is no larger than a predetermined value such that an etching mark formed by the first space area is invisible to the naked eye of a user of the touch panel.

In accordance with the second aspect of the present invention, a touch panel includes a dummy area having a first width, and a space area adjacent to the dummy area and having a second width, wherein a ratio of the second width to the first width is no larger than a predetermined value such that an etching ark formed by the space area is invisible to the naked eye of a user of the touch panel.

In accordance with the third aspect of the present invention, a touch panel includes a dummy area having a first width, and a space area adjacent to the dummy area and having a second width, wherein a ratio of the second width to the first width is no larger than 0.2.

In accordance with the fourth aspect of the present invention, a method for causing an etching mark of a touch panel to be unapparent includes: providing a plurality of touch units, each of which comprises a dummy area having a first width, and a first space area having a second width, wherein the first space area is adjacent to the dummy area; and causing a ratio of the second width to the first width to be no larger than a predetermined value such that an etching mark formed by the first space area is invisible to the naked eye of a user of the touch panel.

In accordance with the fifth aspect of the present invention, a method for decreasing a visibility of an etching mark of a touch panel includes: providing a dummy area having a first width, and a space area adjacent to the dummy area and having a second width; and causing a ratio of the second width to the first width to be no larger than a predetermined value such that an etching mark formed by the space area is invisible to the naked eye of a user of the touch panel.

### BRIEF DESCRIPTION OF THE DRAWINGS

Other objectives, advantages and the efficacy of the present invention will be described in detail below taken from the preferred embodiments with reference to the accompanying drawings, in which:

FIG. 1 is a schematic diagram of a touch panel according to the preferred embodiment of the present invention.

FIG. 2 is a schematic diagram showing the dummy area and the space area as shown in FIG. 1 respectively having a dummy area width and a space area width.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purposes of illustration and description only; they are not intended to be exhaustive or to be limited to the precise form disclosed.

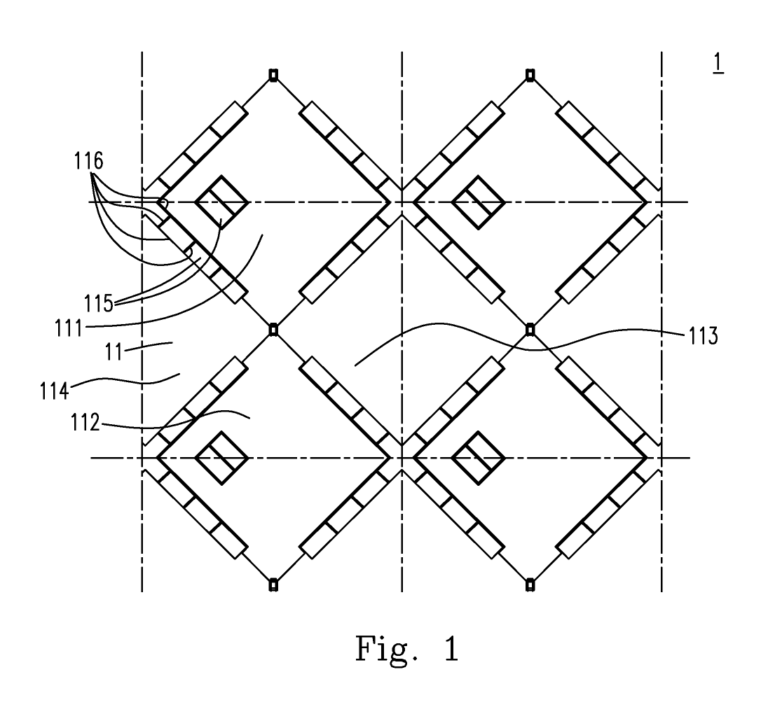

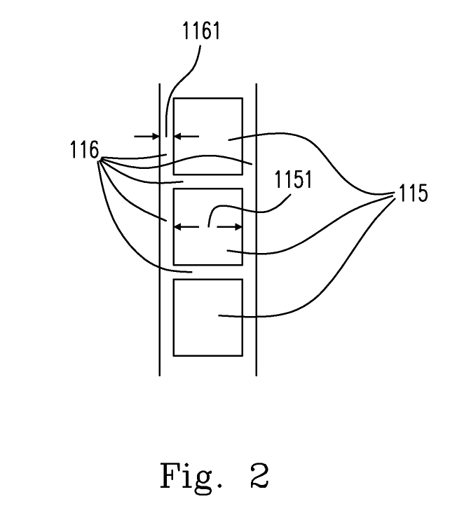

FIG. 1 shows a schematic diagram of a touch panel according to the preferred embodiment of the present invention. In FIG. 1, the touch panel 1 comprises a plurality of touch units 11, each of the plurality of touch units 11 includes a first driving line 111, a second driving line 112, a first sensing line 113, a second sensing line 114, a plurality of dummy areas 115 and a plurality of space areas 116. Each of the plurality of dummy areas 115 has four sides and is surrounded by four adjacent space areas 116 (see FIG. 2).

FIG. 2 shows a schematic diagram showing the dummy area and the space area as shown in FIG. 1 respectively having a dummy area width and a space area width. As shown in FIG. 2, each of the plurality of dummy areas 115 has a dummy area width (a first width) 1151, and each of the plurality of space areas 116 is adjacent to the corresponding dummy area 115, and has a space area width 1161, wherein a ratio of the space area width (a second width) 1161 to the dummy area width 1151 is no larger than a predetermined value such that an etching mark formed by each of the plurality of space areas 116 (e.g., to a specific dummy area 115, the first space area 116 adjacent to the first one of the four sides of this specific dummy area 115 forms a first etching mark, and the second to the fourth space areas 116 adjacent to the second to the fourth of the four sides of this specific dummy area 115 form a second etching mark, and both of the first and the second etching marks are not shown) is invisible to the naked eye of a user of the touch panel. The ratio of the space area width 1161 to the dummy area width 1151 space area width should not be larger than 0.2, When this ratio is larger than 0.2, the etching mark is visible to the user. That is, when this ratio is larger than 0.2, the naked eye of a user of the touch panel can see the etching mark formed by each of the plurality of space areas 116, which means the visibility of the etching mark become obvious, and this definitely should be avoided. Thus, the ratio of the space area width 1161 to the dummy area width 1151 should be kept at ≦0.2.

In FIG. 1, a ratio of the space area width 1161 to the dummy area width 1151 is 0.1 (30:300), thus it fulfills the condition above of being no larger than 0.2. Furthermore, as shown in FIG. 1, the plurality of dummy areas 115 and the plurality of space areas 116 are located at a specific location, and the specific location is one selected from a group consisting of a place between the first driving line 111 and the first sensing line 113, a place between the first driving line 111 and the second sensing tine 114, a place between the second driving line 112 and the first sensing line 113, a place between the second driving line 112 and the second sensing line 114, an interior of the first driving line 111, an interior of the second driving line 112, an interior of the first sensing line 113 (not shown), an interior of the second sensing line 114 (not shown), and a combination thereof.

### Embodiments

1. A touch panel, comprising a plurality of touch units, each of which comprises:
a dummy area having a first width; and
a first space area adjacent to the dummy area and having a second width,
wherein a ratio of the second width to the first width is no larger than a predetermined value such that an etching mark formed by the first space area is invisible to the naked eye of a user of the touch panel.

2. A touch panel according to Embodiment 1, wherein the predetermined value is no larger than 0.2.

3. A touch panel according to Embodiment 1 or 2, further comprising a second space area to a fourth space area, wherein the second space area to the fourth space area all have the second width, the dummy area has a first to a fourth sides, the first space area to the fourth space area are adjacent to the first to the fourth sides respectively such that the second space area to the fourth space area form a second etching mark, and both the first and the second etching marks are invisible to the naked eye of the user.

4. A touch panel according to any one of the above-mentioned Embodiments, further comprising a first driving line, a second driving line, a first sensing line and a second sensing line, wherein the dummy area and the first to the fourth space areas are located at a specific location, and the specific location is one selected from a group consisting of a place between the first driving line and the first sensing line, a place between the first driving line and the second sensing line, a place between the second driving tine and the first sensing line, a place between the second driving line and the second sensing line, an interior of the first driving tine, an interior of the second driving tine, an interior of the first sensing tine, an interior of the second sensing line, and a combination thereof.

5. A touch panel, comprising:
a dummy area having a first width; and
a space area adjacent to the dummy area and having a second width,
wherein a ratio of the second width to the first width is no larger than a predetermined value such that an etching mark formed by the space area is invisible to the naked eye of a user of the touch panel.

6. A touch panel according to Embodiment 5, wherein the predetermined value is no larger than 0.2.

7. A touch panel, comprising:
a dummy area having a first width; and
a space area adjacent to the dummy area and having a second width,
wherein a ratio of the second width to the first width is no larger than 0.2

8. A method for causing an etching mark of a touch panel to be unapparent, comprising:
providing a plurality of touch units, each of which comprises a dummy area having a first width, and a first space area having a second width, wherein the first space area is adjacent to the dummy area; and
causing a ratio of the second width to the first width to be no larger than a predetermined value such that an etching mark formed by the first space area is invisible to the naked eye of a user of the touch panel.

9. A touch panel according to Embodiment 8, wherein the dummy area has a first to a fourth sides, and the method further includes:
providing a second space area to a fourth space area, wherein the second space area to the fourth space area all have the second width;
causing the first space area to the fourth space area to be respectively adjacent to the first to the fourth sides; and
causing the second space area to the fourth space area to form a second etching mark, wherein the first and the second etching marks are both invisible to the naked eye of the user.

10. A touch panel according to Embodiment 8 or 9, wherein the predetermined value is no larger than 0.2.

11. A method for decreasing a visibility of an etching mark of a touch panel, comprising:
providing a dummy area having a first width, and a space area adjacent to the dummy area and having a second width; and
causing a ratio of the second width to the first width to be no larger than a predetermined value such that an etching mark formed by the space area is invisible to the naked eye of a user of the touch panel.

According to the aforementioned descriptions, the present invention discloses a touch panel, wherein there is a specific ratio of the dummy and the space areas of the transparent electrode to cause the etching marks of patterns in the transparent conducting film (e.g., ITO) to be invisible to the naked eye of a user of the touch panel.

While the invention has been described in terms of what is presently considered to be the most practical and preferred embodiments, it is to be understood that the invention needs not be limited to the disclosed embodiments. Therefore, it is intended to cover various modifications and similar configuration included within the spirit and scope of the appended claims, which are to be accorded with the broadest interpretation so as to encompass all such modifications and similar structures.

What is claimed is:

1. A touch panel, comprising a plurality of touch units, each of which comprises:
a dummy area having a first width; and
a first space area adjacent to the dummy area and having a second width,
wherein a ratio of the second width to the first width is no larger than a predetermined value such that an etching mark formed by the first space area is invisible to the naked eye of a user of the touch panel.

2. A touch panel according to claim 1, wherein the predetermined value is no larger than 0.2.

3. A touch panel according to claim 1 further comprising a second space area to a fourth space area, wherein the second space area to the fourth space area all have the second width, the dummy area has a first to a fourth sides, the first space area to the fourth space area are adjacent to the first to the fourth sides respectively such that the second space area to the fourth space area form a second etching mark, and both the first and the second etching marks are invisible to the naked eye of the user.

4. A touch panel according to claim 3, further comprising a first driving line, a second driving line, a first sensing line and a second sensing line, wherein the dummy area and the first to the fourth space areas are located at a specific location, and the specific location is one selected from a group consisting of a place between the first driving line and the first sensing line, a place between the first driving line and the second sensing line, a place between the second driving line and the first sensing line, a place between the second driving line and the second sensing line, an interior of the first driving line, an interior of the second driving line, an interior of the first sensing line an interior of the second sensing line, and a combination thereof.

5. A touch panel, comprising:
a dummy area having a first width; and
a space area adjacent to the dummy area and having a second width,
wherein a ratio of the second width to the first width is no larger than a predetermined value such that an etching mark formed by the space area is invisible to the naked eye of a user of the touch panel.

6. A touch panel according to claim 5, wherein e predetermined value is no larger than 0.2.

7. A touch panel, comprising:
a dummy area having a first width; and
a space area adjacent to the dummy area and having a second width,
wherein a ratio of the second width to the first width is no larger than 0.2.

8. A method for causing an etching mark of a touch panel to be unapparent, comprising:
providing a plurality of touch units, each of which comprises a dummy area having a first width, and a first space area having a second width, wherein the first space area is adjacent to the dummy area; and
causing a ratio of the second width to the first width to be no larger than a predetermined value such that an etching mark formed by the first space area is invisible to the naked eye of a user of the touch panel.

9. A method according to claim 8, wherein the dummy area has a first to a fourth sides, and the method further includes:
providing a second space area to a fourth space area, wherein the second space area to the fourth space area all have the second width;
causing the first space area to the fourth space area to be respectively adjacent to the first to the fourth sides; and
causing the second space area to the fourth space area to form a second etching mark, wherein the first and the second etching marks are both invisible to the naked eye of the user.

10. A method according to claim 8, wherein the predetermined value is no larger than 0.2.

11. A method for decreasing a visibility of an etching mark of a touch panel, comprising:
providing a dummy area having a first width, and a space area adjacent to the dummy area and having a second width; and
causing a ratio of the second width to the first width to be no larger than a predetermined value such that an etching mark formed by the space area is invisible to the naked eye of a user of the touch panel.
